(19) United States
(12) Patent Application Publication
(10) Pub. No.: US 2006/0227179 A1
(43) Pub. Date: Oct. 12, 2006

(54) Droplet deposition apparatus

(76) Inventors: Stephen Temple, Cambridge (GB); Robert Harvey, Cambridge (GB); Robert J. Lowe, Cambridge (GB); Paul R. Drury, Hertfordshire (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/538,311

(22) PCT Filed: Dec. 22, 2003
(86) PCT No.: PCT/GB03/05626

§ 371 Date: Feb. 21, 2006

(30) Foreign Application Priority Data
Dec. 20, 2002 (GB) 02296556

(51) Int. Cl. B41J 2/045

(52) U.S. Cl. 347/68

(57) ABSTRACT

A drop on demand ink jet printer, has a passive component defining ink ejector chambers with respective ejection nozzles; and an actuator component comprising a body with an opening and an actuator structure located within the opening. The actuator structure is formed of piezoelectric material by molding from a slurry or vacuum forming of flexible sheets using formers that are burned away. MEMs techniques may also be employed to build the structure on a silicon wafer using a succession of masked deposition; etch back and similar process steps.

The present invention relates to droplet deposition apparatus and in particular drop on demand ink jet printers, components therefor, and their manufacture.

Drop on demand inkjet printers typically fall under one of two broad categories: bubble-jet or mechanical. Bubble-jet printers eject a drop by selectively heating a fluid and generating a bubble that provides sufficient force to eject a droplet. Mechanical printers eject a drop by varying the volume of a chamber to apply pressure to the fluid in the chamber and thus eject a drop. The present invention is primarily concerned with mechanical drop on demand ink jet printers and in particular mechanical printers using a piezoelectric material. Consequentially bubble jet devices will not be discussed in any greater detail.

The piezoelectric material conventionally utilised in ink jet printing is a lead zirconate titanate (PZT) ceramic material. PZT is relatively fragile and is manufactured as sheets of a sintered material. The raw sheets of material are machined either mechanically or through some other process to form individual actuators.

One particularly elegant form of an actuator is one produced and made commercially available by the applicant company under the product code XJ500. Channels are sawn into the piezoelectric material such that they are bounded on either side by a wall. A cover plate is provided to close the top surface of the channels and a nozzle plate is attached to the open front of the channel. Nozzles are formed extending through the nozzle plate and communicate with the channels. Electrical voltages applied across the walls cause the walls to deflect in shear. The deflection pressurises ink in the channel and causes a droplet to be ejected through the nozzle.

It has been proposed to mould a piezoelectric print head and certain structures are proposed. One structure is proposed in WO 00/16981 relating to a circular chamber having a lower wall of piezoelectric material formed by moulding.

Whilst forming an actuator by moulding is quick, some accuracy is lost over the traditional mechanical sawing methods. In particular, the piezoelectric material shrinks on firing often up to 30%. This shrinkage is not uniform across the piezoelectric material and this leads to actuators having different channel spacing along the length of the array.

The present invention seeks to address this and other problems.

According to one aspect of the present invention there is provided an actuator component for a drop on demand ink jet printer, said component comprising a body having a top surface, an opening in said top surface extending into said body along an opening axis, an actuator structure located substantially within said opening and electrode means; said electrode means being disposed so as to be able to apply a field to said actuator structure so as to cause said actuator structure to deform.

In a preferred embodiment the body does not significantly alter its dimensions when exposed to extremes of heat. It is preferred that the coefficient of thermal expansion (TCE) of the body is similar to that of the actuator and in the case of piezoelectric or magnetostrictive material the particularly preferred materials are silicon or alumina. Other appropriate materials may be found by routine experimentation. Where the material is silicon the opening may be formed by reactive ion etching (RIE) or deep reactive ion etching (DRIE). Other techniques such as laser cutting or machining will also be appropriate if the material is alumina.

It is preferred that the actuator structures are isolated actuator structures i.e. each structure is separate and distinct from adjacent actuator structures and not part of a common actuator structure. Actuator structures would not be isolated in this context if—for example—they comprised a self-supporting sheet of actuator structures. Isolated actuator structures may nonetheless be connected by a thin layer of material having the same properties as the actuator structures.

The opening may extend from the top surface to a bottom surface opposite said top surface. The opening extending into the body from the top surface may have sides that are perpendicular to the top surface. Alternately, the surfaces of the opening may lie at a non perpendicular angle to the top surface i.e. the opening may taper inwards or outwards as it extends from the top surface.

The shape of the opening may be used to define the shape of the actuator element or additional mould elements may be formed in the opening to define the actuator shape that is preferably generally convex or follows the outline of a frustum. The actuator may taper along said opening axis and further comprise a flat portion at the end of said taper, said flat portion comprising an upper surface and a lower surface; said upper and lower surfaces lying parallel with said top and bottom surfaces. The upper surface may lie in the plane of said top surface. The lower surface may lie within said opening and both the top surface and said bottom surface can move in said opening direction.

Preferably at least a part of the body and mould portions that define the actuator shape are removed once the actuator has been formed to enable a freer movement of the actuator though the actuator may remain attached to at least a portion of the body. The removal of this material may be performed by etching or some other technique from the surface of the body opposite the top surface. The opening may then extend through the body with the actuator structure defining an impermeable barrier across it.

The opening may be circular but more preferably is elongate in shape. A number of openings may be provided through the body in either a linear array or matrix arrangement.

The electrodes that are disposed so as to be able to apply a field across the actuator may be formed for example of aluminium or nickel. It is preferred that one of the electrodes constitutes a ground electrode and the other provides the active electrode and it is preferred that they extend over opposite surfaces of the piezoelectric structure.

A diaphragm may be provided that extends over one or both surfaces of the body. The actuator structure may act on said diaphragm thereby deflecting at least portions of it away from the respective surface. Where a cover plate is attached to the body thereby defining an ejection chamber the actuator should be arranged so as to effect a pressure disturbance on fluid contained within the ejection chamber. The diaphragm can provide both a uniform wall for the base of the chamber as well as protection for the actuator against chemical attack from the ink.

As an alternative or additionally to the diaphragm, any space between the actuator structure, the opening and the plane of the top or bottom surface may be filled by a compressible material such as, for example, silicon rubber.

The material of the cover plate is preferably matched to the body in terms of its coefficient of thermal expansion and the shape of each chamber is preferably matched to the shape of the openings i.e. where the opening is elongate the channel is elongate.

According to a second aspect of the present invention there is provided a component for ejecting a droplet in a direction of droplet flight, said component comprising an actuator structure displaceable by actuation in the direction of said droplet flight; said actuator defining in part an ejection chamber and comprising a port through which said droplet is ejected.

In the preferred embodiment the actuator structure defines at least three walls of the ejection chamber. The chamber is preferably generally convex or follows the outline of a frustum with the port being provided in the base. The actuator is displaced in the direction of ejection flight thereby ejecting a drop.

The actuator may be located within an opening provided in a base structure or mounted to a top surface. Ink may be supplied to the chamber from either end with the top surface of the base structure closing the chamber or through openings formed in the base structure.

A nozzle plate with nozzles may be applied to a surface of the actuator structure such that the nozzles are in fluid communication with the ports.

The actuator structures are preferably non-planar and form relatively complex three-dimensional shapes that are generally convex or follow the outline of a frustum.

The actuator structure may be formed, for example,, a process of sputtering, from a flexible sheet of piezoelectric material, from a slurry containing piezoelectric particles. Piezoelectric particles may be provided in a sacrificial matrix, typically a thermoplastic material, though other materials, including thermosetting materials such as epoxy, will suit.

The opening is etched through the body and a sacrificial mould element provided within the opening. This is used, with the body to form a piezoelectric structure by the known technique of ceramic injection moulding. The body is then subjected to a high temperature so as to sinter the piezoelectric material. Where the sacrificial mould element is a polymeric material this is burned out and removed during the sintering step.

In a particularly elegant form of this method the sacrificial mould element is part of the body. Reactive ion etching (RIE) forms a tapered opening that may be used as the mould. After the sintering step the body may be etched from the opposite side to release the piezoelectric structure. Since RIE is a selective process the silicon can be removed without removing the piezoelectric structure.

This elegant technique may similarly be used where piezoelectric material is deposited as thin layers either singly or as multiple layers. The layers may be deposited either by sputter coating or as the thin flexible layers described above.

In a preferred method the body of silicon is reactive ion etched to form the opening. The piezoelectric material is provided in the form of a flexible sheet that is laid against one side of the planar body. The sheet is subsequently subjected to a pressure difference between the opening and the opposite side of the sheet with the lower pressure being located within the opening. A moulding feature may be provided within the opening.

The flexible sheet is thus moulded into a three dimensional structure and may be fired to sinter the piezoelectric particles in the flexible sheet and burn out the matrix carrier. Electrodes are deposited on the inner and outer surfaces of the formed piezoelectric structure. A diaphragm and/or polymeric material may be deposited to insulate the electrode material from the ink.

According to a further aspect of the present invention there is provided a method of forming a component for an ink jet print head comprising the steps a) providing a body having a mould feature, b) forming a deformable actuator structure, the shape of said actuator structure being defined, at least in part by said mould feature, c) removing at least a portion of said mould feature and d) providing electrode means; said electrode means being disposed so as to be able to apply a field to said actuator structure so as to cause said actuator structure to deform whilst said actuator structure is attached to said body.

The body provides support to the actuator both in manufacture and use and provides mould features for partly defining the shape. The actuator is preferably non planar and may be located within openings provided in the body.

According to yet a further aspect of the present invention there is provided a method of forming a component for an ink jet print head comprising the steps a) providing a body having a top surface, b) forming an opening in said top surface and extending into said body and; c) forming within, said opening an actuator structure; said actuator structure remaining attached to said body during actuation.

According to still a further aspect of the present invention there is provided a channelled component for a drop on demand ink jet printer comprising elongate channel walls defining a plurality of elongate liquid channels, each channel comprising one wall that is resiliently deformable in an actuation direction orthogonal to the channel length; a respective ejection nozzle connected with the channel at a point intermediate its length; a liquid supply providing for continuous flow of liquid along said channel; acoustic boundaries at respective opposite ends of the channel serving to reflect acoustic waves in the liquid of the channel wherein the inter-channel spacing of said acoustic boundaries is different to the inter-channel spacing of said nozzles.

In a preferred embodiment the inter-channel spacing of said acoustic boundaries is less than that of the inter-channel spacing of said nozzles. The channels may be chevron shaped with the chevron angle becoming more acute with increasing distance from a channel that is substantially straight.

It is preferred that the substantially straight channel is central to the module and a reverse series of chevron shaped channels is arranged on the opposite side.

It is preferred that the channels are arranged on a tile with the array of nozzles extending linearly across said tile. A plurality of like tiles may be butted together along respective edges and wherein there is provided an array nozzles having an equal linear nozzle spacing across the width of the like tiles and across the butt joint.

The edges of the butt joint may be serrated with the respective serrations capable of being interleaved.

An actuator component with actuators having a similar shape to each of the different shaped channels may be laminated to the channelled component to form an ink jet print head.

A chamber component may be provided that comprises a plurality of ejection chambers having different dimensions and containing an ejection fluid, an actuator component comprising a plurality of actuators haying different dimensions, wherein said actuator component is joined to said chamber component such that an ejection chamber and an actuator are combined to enable the actuator to effect a pressure disturbance in said fluid in order to eject droplets from said chambers and wherein said ejected droplets have substantially identical characteristics.

The invention will now be described by way of example only with reference to the following diagrams in which:

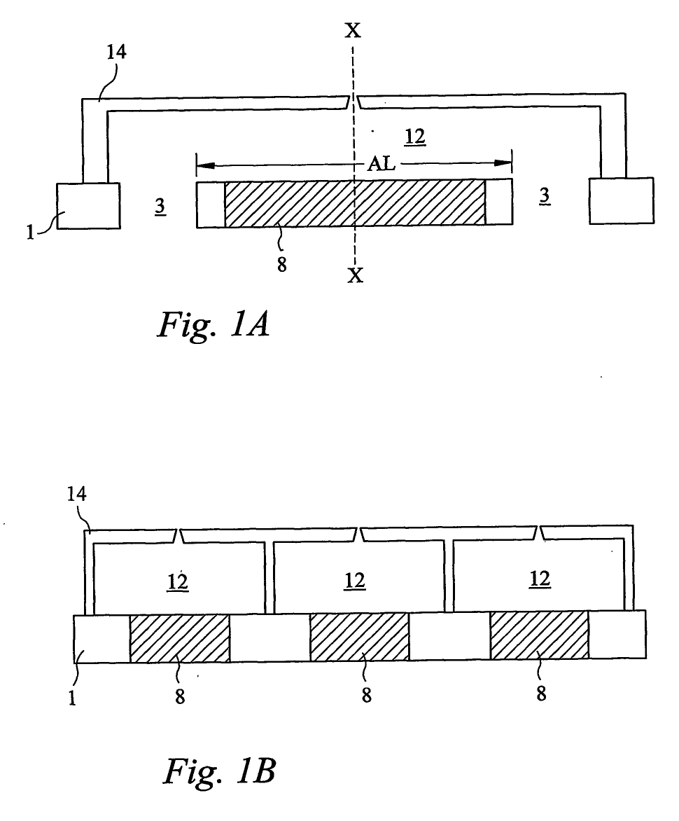

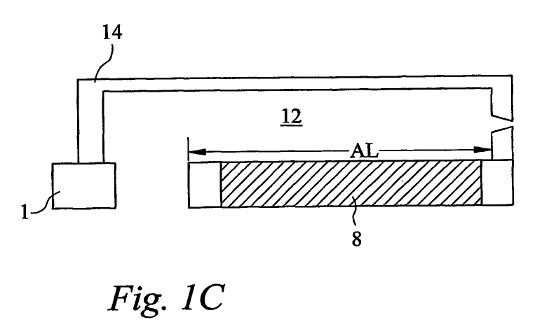

FIGS. 1a, b and c depict an inkjet component according to the present invention.

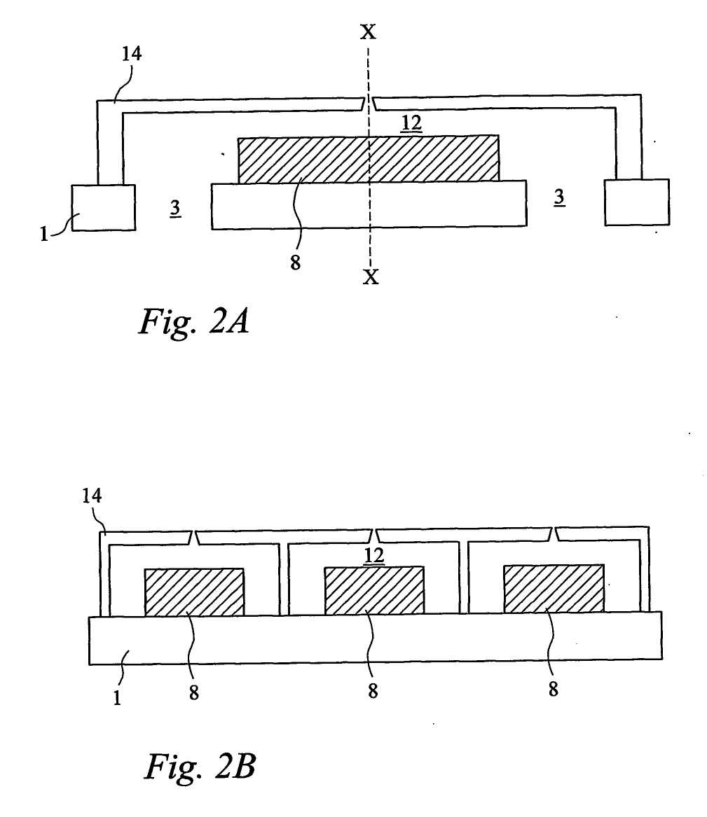

FIGS. 2a and b depict an alternative inkjet component according to the present invention.

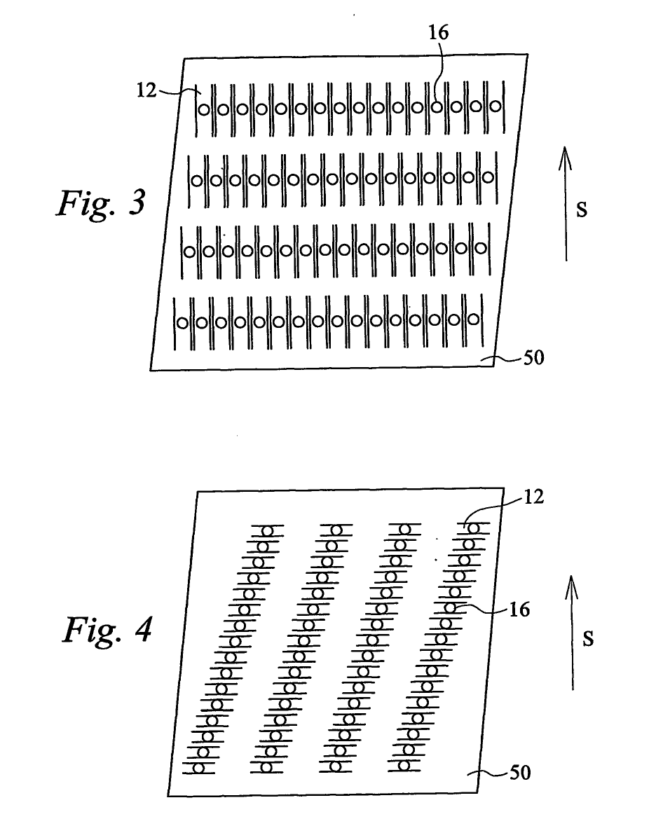

FIG. 3 depicts a channel arrangement on a module.

FIG. 4 depicts an alternative arrangement of channels in a module.

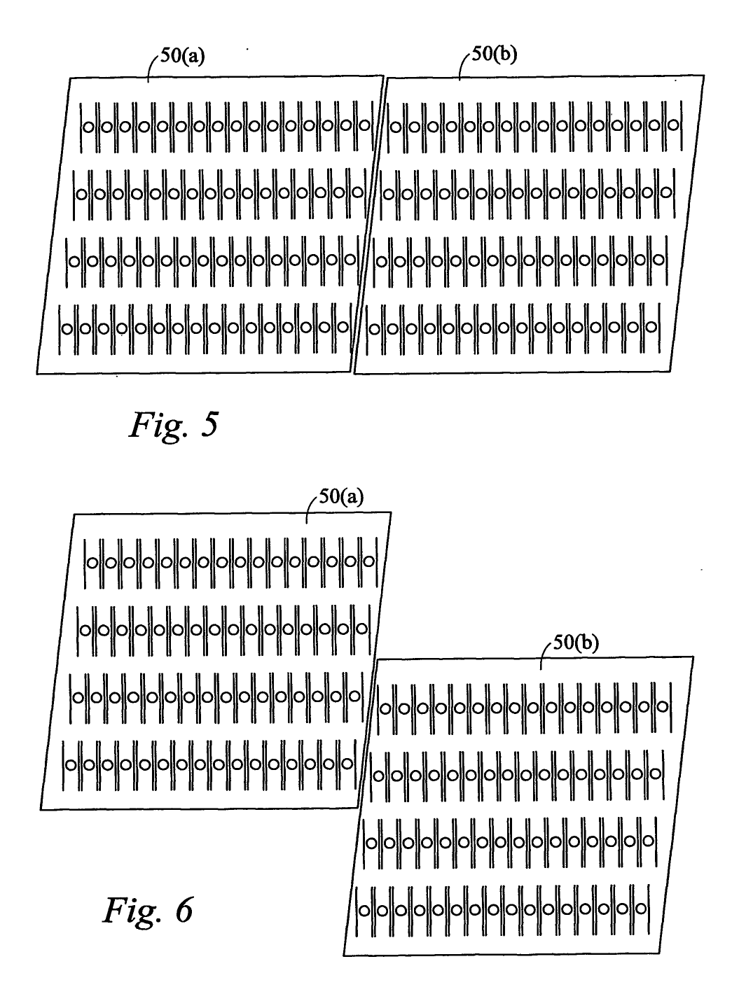

FIG. 5 depicts an arrangement when two modules are butted together.

FIG. 6 shows an alternative butting arrangement.

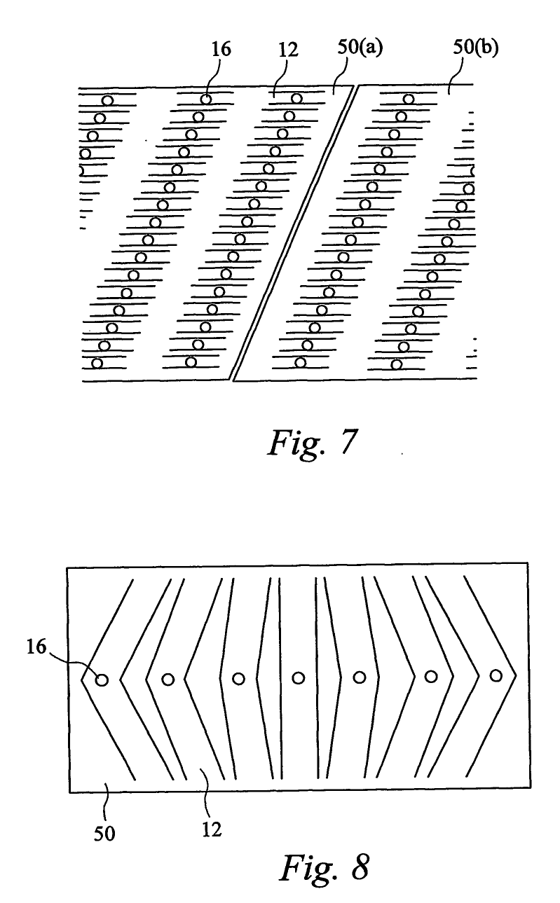

FIG. 7 is a diagram of butted modules with the channels rotated by 90°.

FIG. 8 is an alternative channel arrangement.

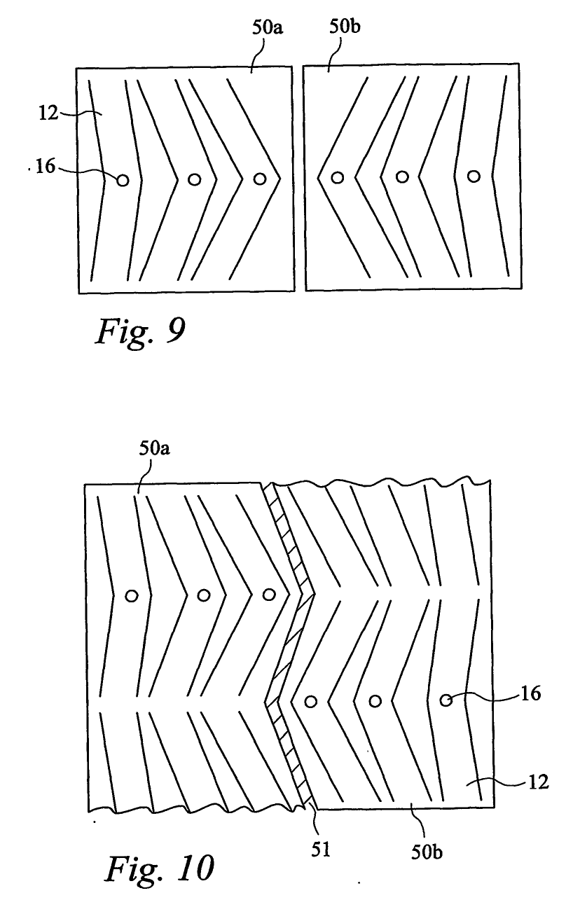

FIG. 9 is a diagram of butted modules with chevron shaped channels.

FIG. 10 depicts an alternative butting arrangement for the modules comprising chevron shaped channels.

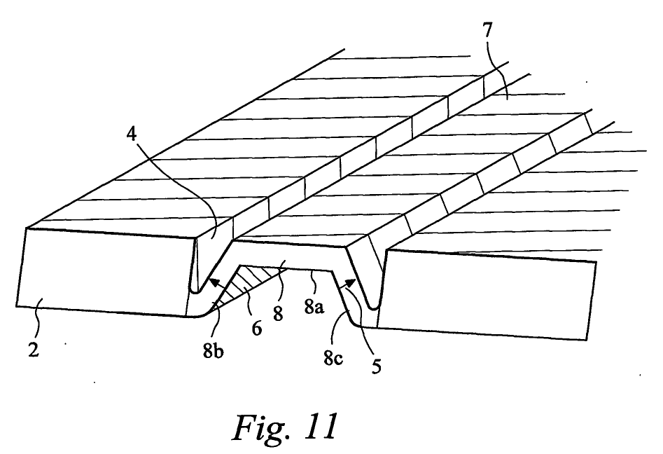

FIG. 11 shows an actuator component according to the present invention.

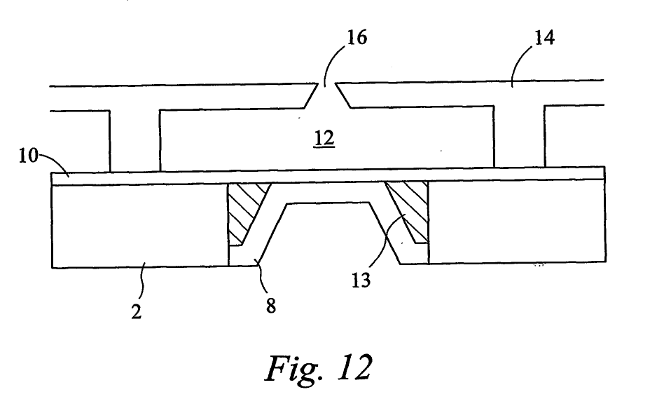

FIG. 12 shows a print head incorporating the component of FIG. 1.

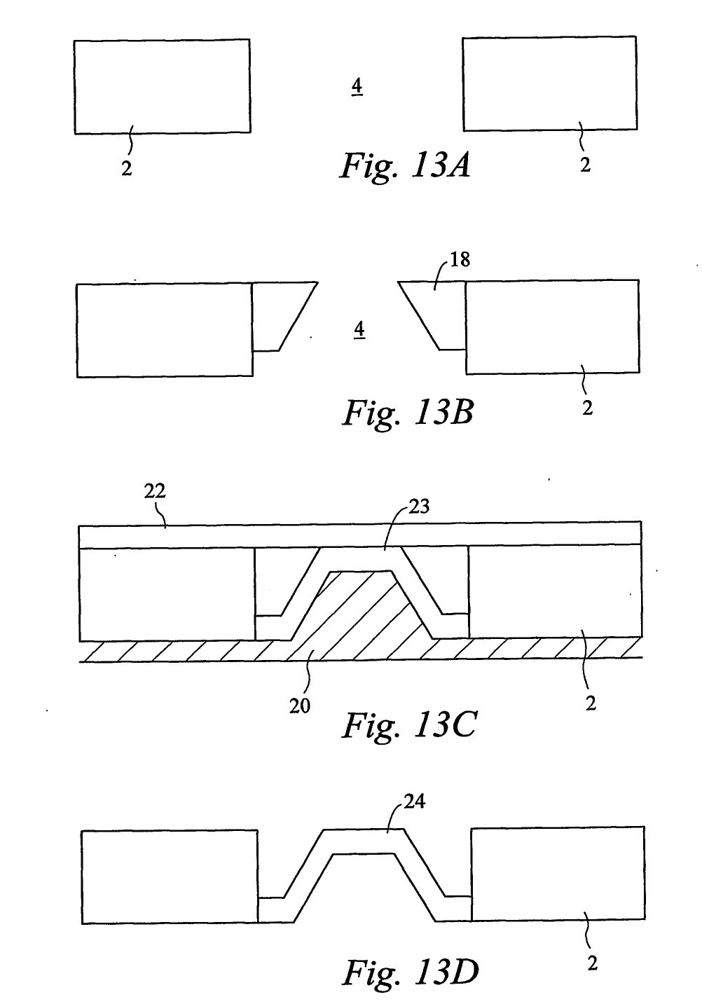

FIGS. 13a to 13d show a method of manufacturing a component according to one embodiment.

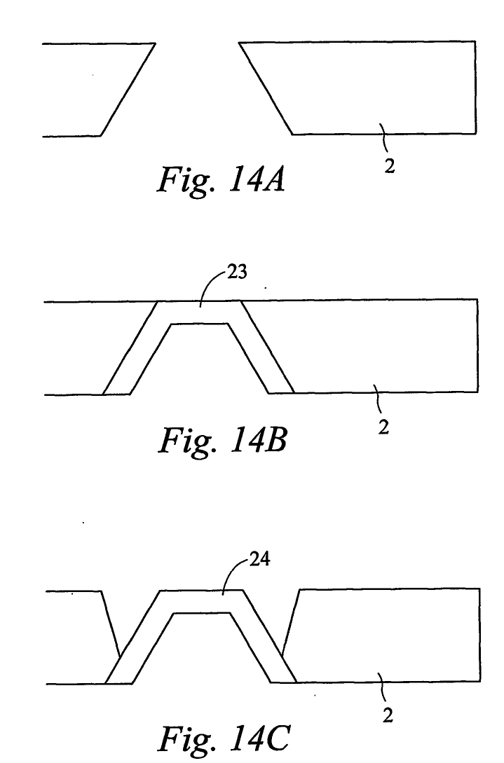

FIGS. 14a to 14c depict a further method of manufacturing the component.

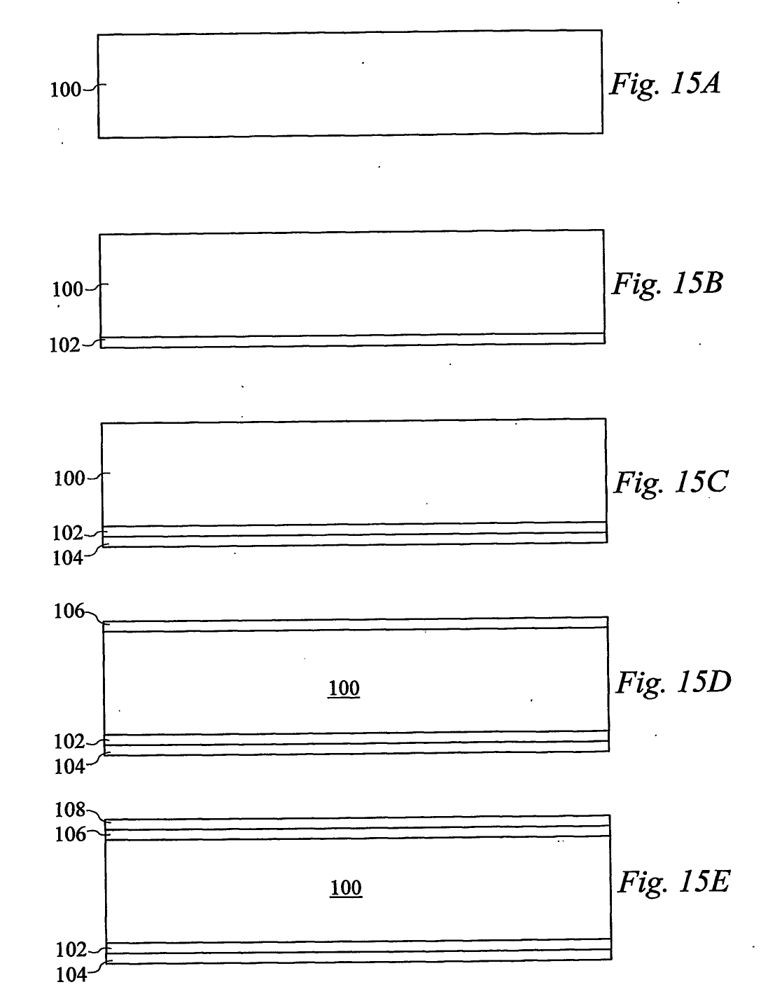

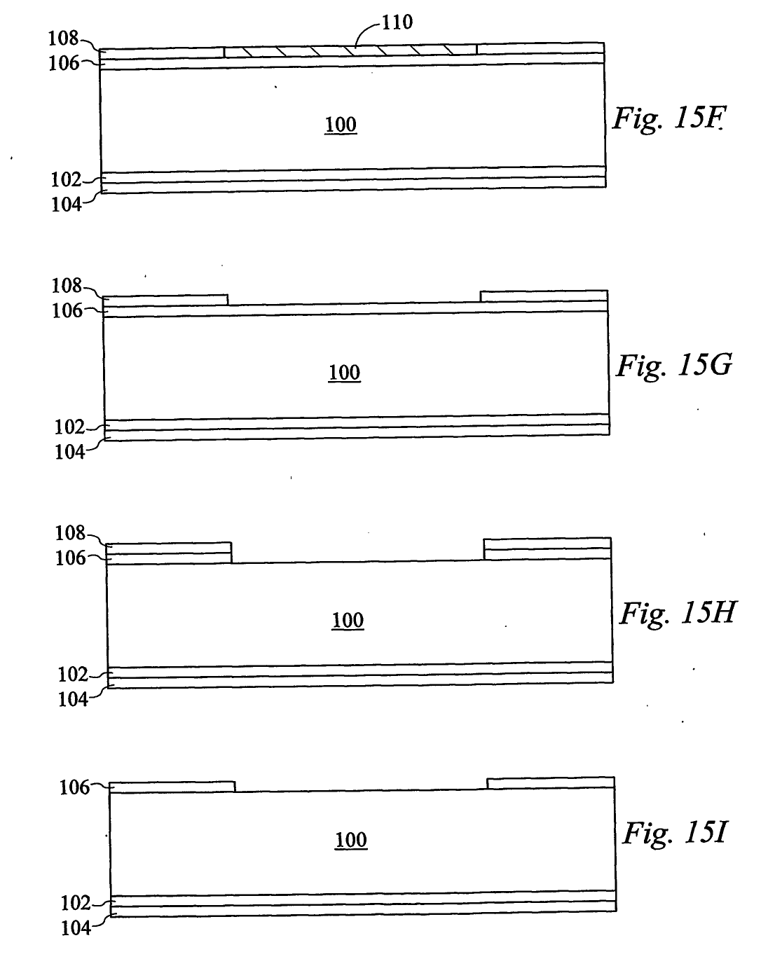

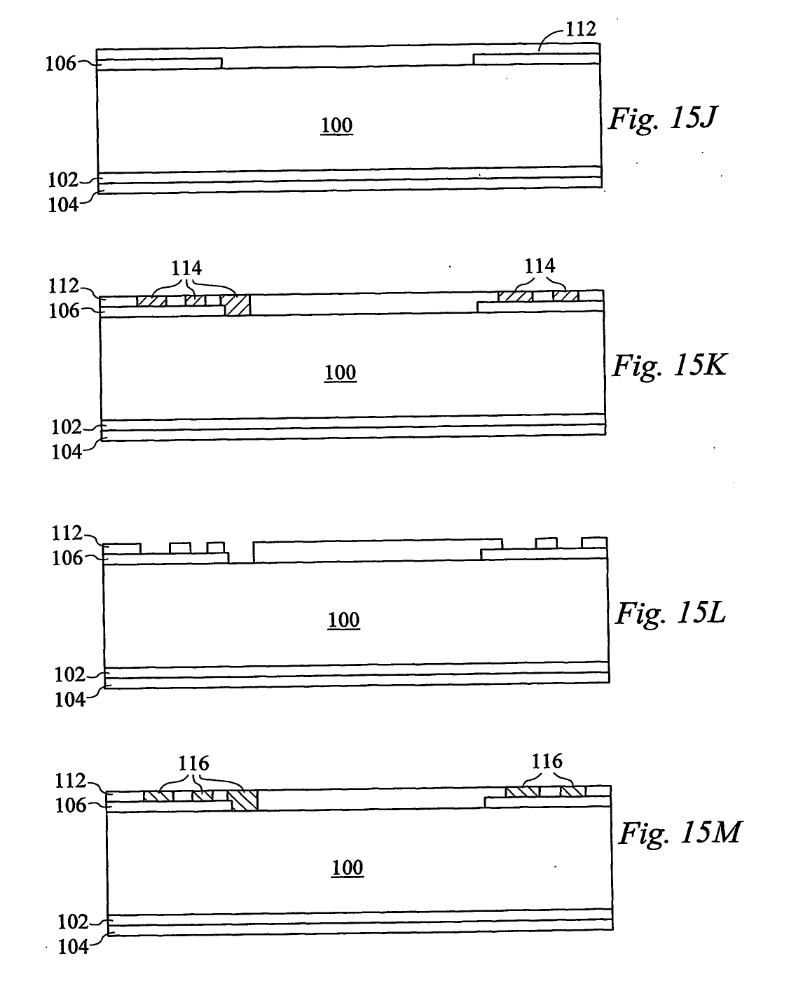

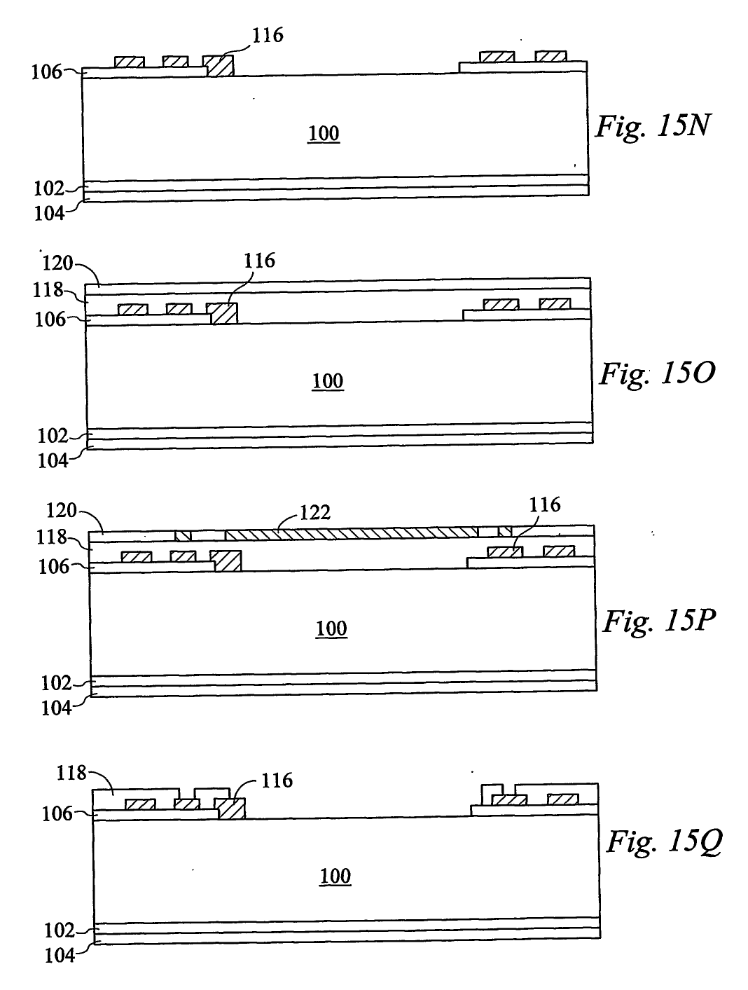

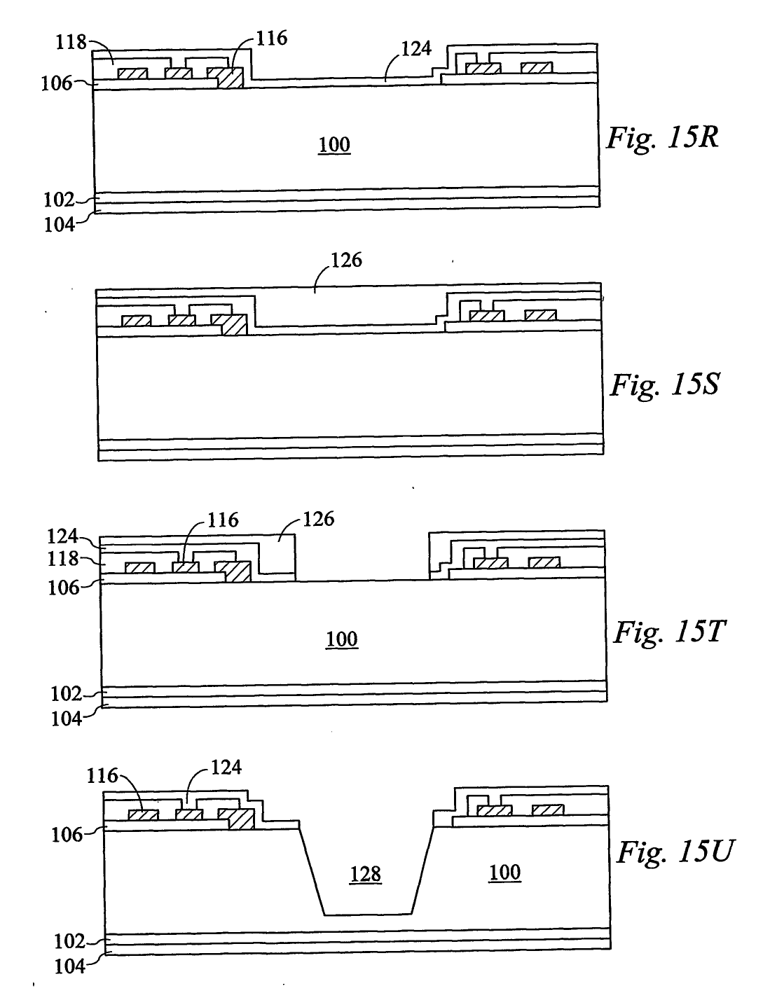

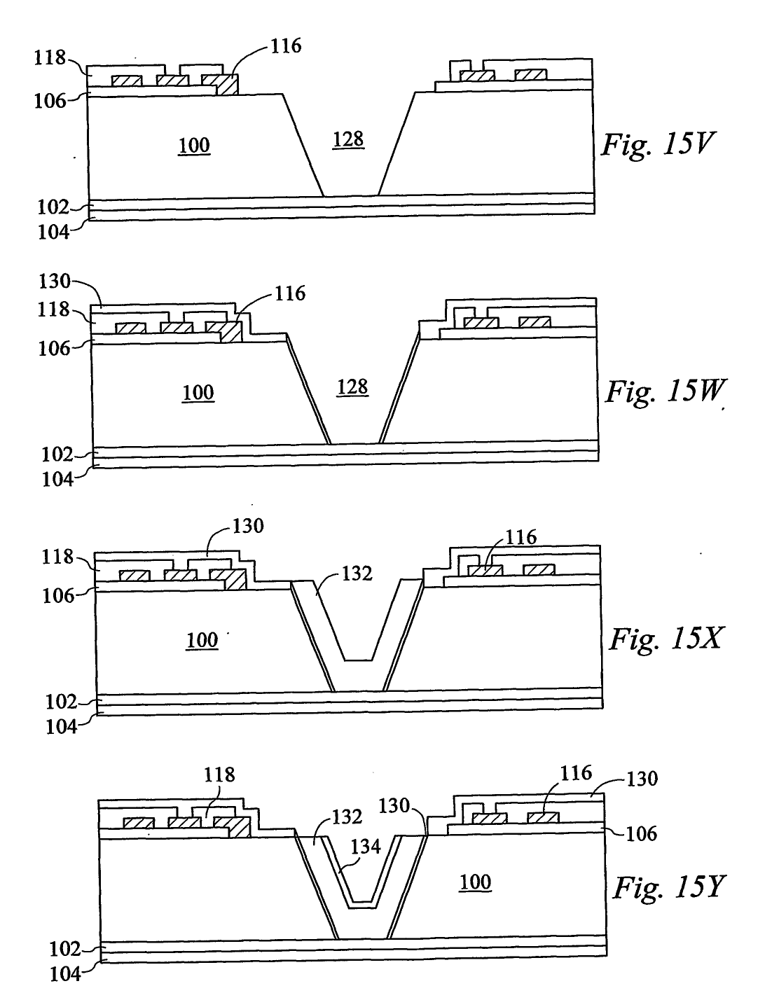

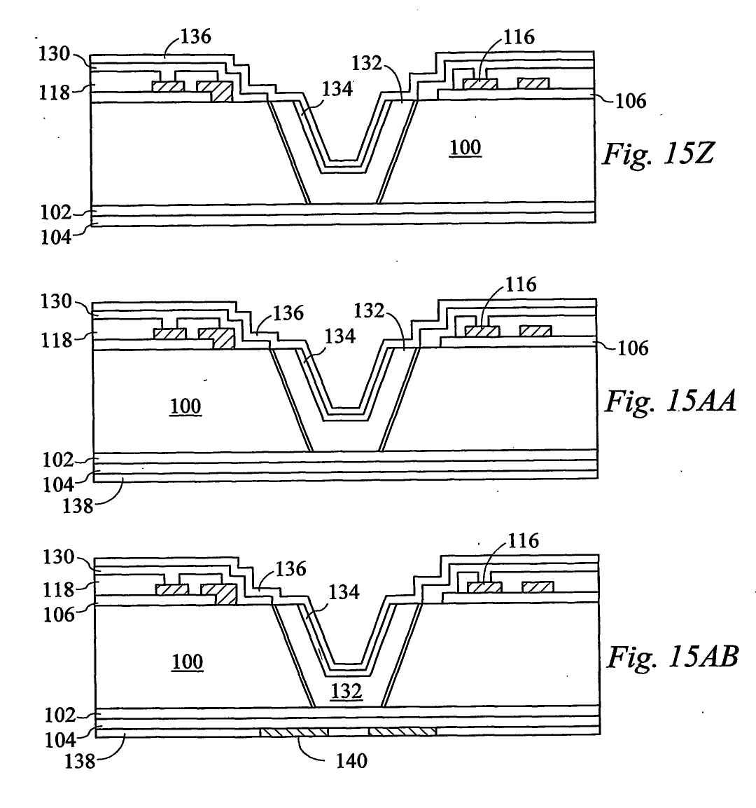

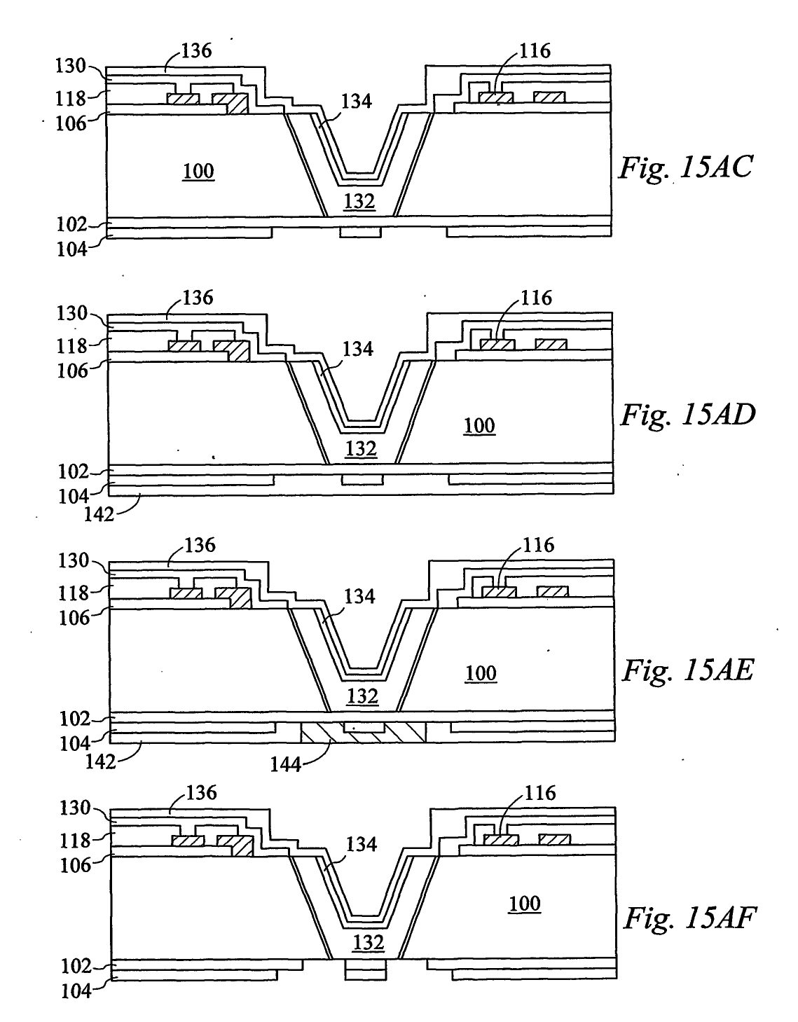

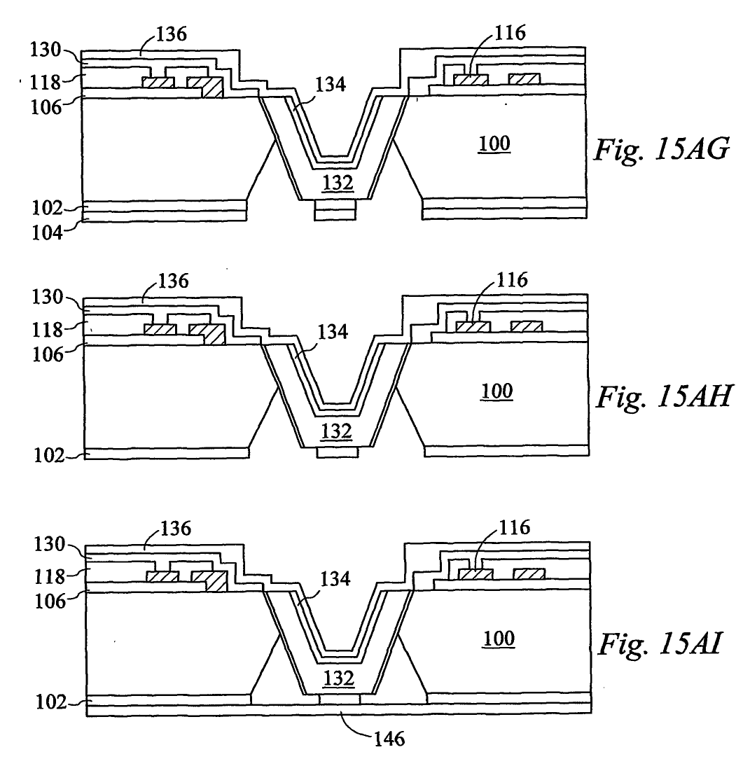

FIGS. 15a to 15ai depict a method of manufacturing an actuator component.

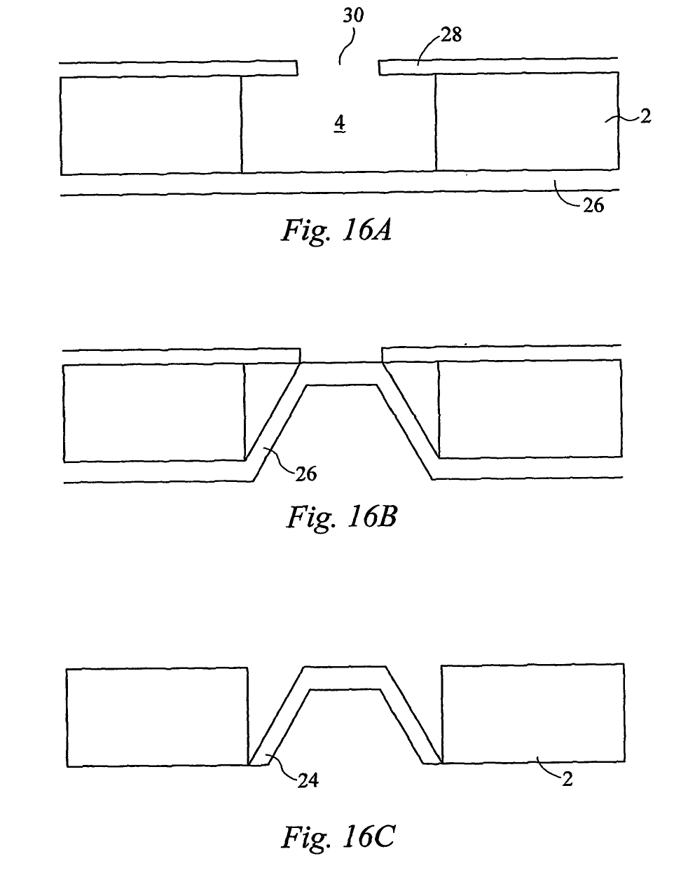

FIGS. 16a to 16c similarly depict a further method of manufacturing the component.

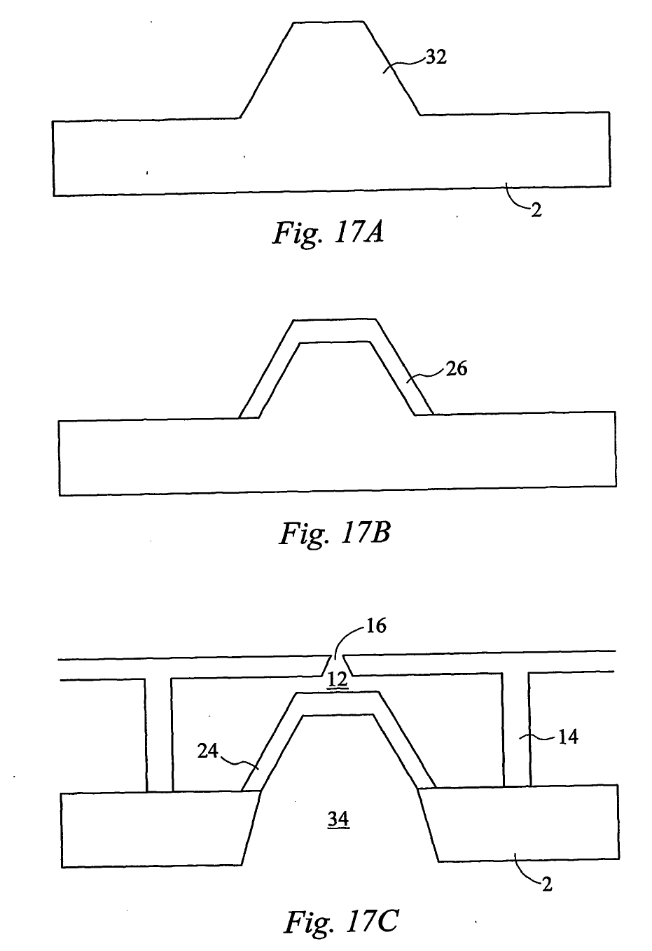

FIGS. 17a to 17c show an alternative method of manufacture where a body acts as the mould and final support component.

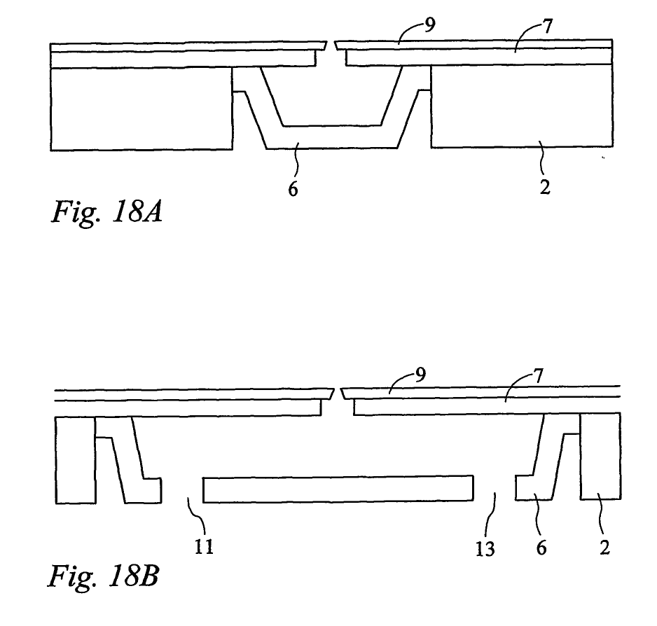

FIG. 18a and 18b are diagrams of an alternative actuator structure.

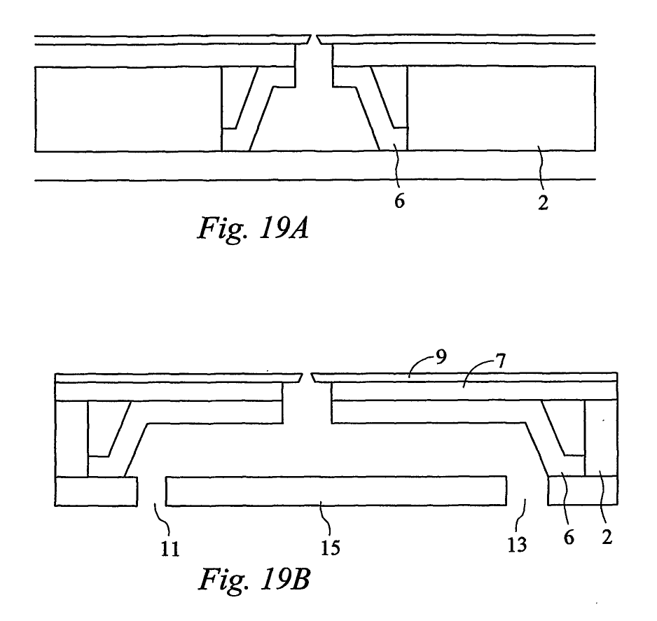

FIGS. 19a and 19b are diagrams of an alternative actuator structure.

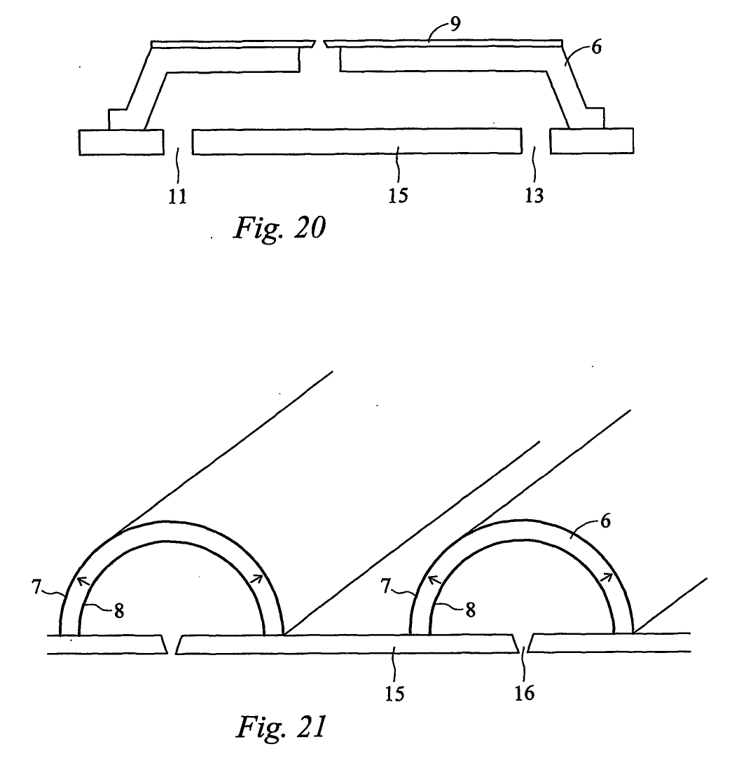

FIG. 20 depicts an alternative actuator structure.

FIG. 21 depicts another alternative actuator structure.

In the Figures, like parts are accorded the same reference numerals.

Referring first to FIGS. 1(a) and 1(b), where FIG. 1(b) is a sectional view taken across line X-X of FIG. 1(a), a pulsed droplet print head consists of a cover component 14 and an actuator component 1, with an ejection chamber 12 defined between these components.

The cover component 14 is formed of a nickel alloy, a material thermally matched to the material of the actuator component 12 which is primarily silicon but also comprises an active portion 8. The ejection chamber is elongate and has an acoustic length AL defined by a distance between ink supply ports 3 formed through the actuator component. The change in the depth of ink at the supply port provides an acoustic boundary that efficiently reflects an acoustic wave travelling in the ink.

The supply ports 3 are arranged to either both supply ink into the chamber or to allow circulation of the ejection fluid through the chamber by passing fluid into the chamber through one port and removing ink from the chamber through the second port. Where circulation of ejection fluid is desired a flow rate along the chamber of the order ten or more times the maximum volume flow rate through the noble is desired. It is desired that the ports extend across the entire width of the channel or at least a substantial proportion of the channel.

In operation, the active portion 8 of the actuator moves either towards or away from the ejection chamber and initiates pressure waves travelling longitudinally in opposite directions along the channel. The pressure waves are reflected at the acoustic boundaries adjacent the supply ports and converge at the nozzle to effect droplet ejection.

To generate a longitudinally travelling acoustic wave the movement of the actuator into the channel should be quick, less than AL/c where c is the speed of sound through the ejection fluid. Preferably the time taken to move the actuator towards or away from the chamber is at most half AL/c and even more preferably an order of magnitude less than AL/c. The distance of the movement of the active portion into or away from the channel need not be great and sufficient ejection force may be generated by a travel into or away from the channel of 50 nm or below and sometimes as low as 10 nm. This is in the context of a channel of preferably 1 mm to 10 mm in length, 30 to 60 microns in depth and 30 to 100 microns in width. The distance of movement can accordingly be seen to be less than 10⁻² and indeed less than 10⁻³ of the smallest dimension of the ejection chamber.

By operating the active portion a number of times quickly in succession it is possible to increase the volume of a droplet of fluid ejected from the nozzle. Depending on the mode of operation selected it is possible to either eject additional volumes of ink whilst a droplet is still attached to a nozzle plate or eject additional volumes of ink in additional, separate droplets. Because of aerodynamic effects, these additional droplets will usually travel faster than a previously ejected droplet of ink. If the print head operates according to the second mode the later ejected droplets merge with the previously ejected droplet of ink prior to or on its arrival at the substrate. The technique of varying the volume of ink ejected is called greyscale and is described in greater detail in EP-A-0 422 870 (incorporated herein) and consequently will not be described in greater detail.

The structures of FIGS. 1(a) and 1(b) are collectively known as “side shooter” structures as ink is deposited through a nozzle positioned part way along the length of an ejection chamber and the direction in which an ejected droplet travels is orthogonal to the direction of elongation of the chamber. The structure, however, may be modified to form what is known in the art as an “end shooter” and depicted in FIG. 1(c). Like in the embodiment of FIG. 1a, the print head comprises a cover component 14 and an actuator component 1. The nozzle, however, is located in an end wall of the ejection chamber 12 such that an ejected droplet travels in direction parallel with the direction of elongation of the chamber.

The direction of movement of the active portion 8 is again towards or away from the ejection chamber. In a similar manner to the side shooter construction this movement initiates an acoustic wave that travels the length of the chamber and is reflected by the acoustic boundary formed by the ink supply port. The reflected wave converges at the nozzle thereby ejecting a droplet. This ejection technique and waveforms appropriate for ejecting a droplet are described in WO 95/25011 (incorporated herein by reference)

For a greyscale print head ejecting a plurality of droplets in quick succession to build an image of appropriate tone on the paper, a chamber length of around 1 to 2 mm is preferred. For a binary print head ejecting a single sized droplet the chambers preferably have a length of the order 1 cm.

A further form of a channel pulsed printhead is shown in FIGS. 2 (a) and (b). In this situation the actuator component comprises an active portion 8 mounted on the non-active base 1.

The active portion is actuated to increase and decrease the volume of the ejection chamber 12. This initiates an acoustic wave that travels longitudinally within the chamber and that is reflected at the acoustic boundaries which are defined by the step changes in ejection chamber depth at either end of the active portion 8.

What has been said above in relation to the operation of FIGS. 1(a) and 1(b) applies generally also to FIGS. 2(a) and 2(b). It is also possible to have an end shooter arrangement as shown generally in FIG. 1(c) with an active portion 8 mounted on a non-active base.

Acoustic printing as described above is one mechanism of ejecting a droplet using a mechanical actuator. A further mechanism is impedance printing. In impedance printing the large acoustic boundaries are replaced by narrow ink inlets having high impedance. Upon actuation, the mechanical actuator deflects into the ejection chamber and ink, prevented from leaving the ejection chamber by the high impedance ink inlet, is squirted from the nozzle—akin to a toothpaste tube. Impedance print heads require the actuators to travel a greater distance toward and from the ejection chamber than acoustic print heads and generally require the speed of deflection to be slower. The ejection chambers are also smaller.

The ejection chambers are arranged side by side as an array and are formed in a module. The module, shown in FIG. 3, arranges four arrays of ejection channels on a tile in parallel arrays. The module is arranged to scan over the media to be printed in a scanning direction S. Each of the arrays has nozzles arranged at a constant pitch and each array is offset from the other arrays in a direction orthogonal to the scanning direction.

The module of FIG. 3 comprises 64 channels arranged as four arrays of 16 ejection chambers 12. Each array is individually capable of printing at a drop density of between 100 dpi and 360 dpi and is offset from an adjacent array in a direction orthogonal to the scanning direction by p/n where p is the nozzle pitch and n is the total number of arrays. This allows a module printing density of n times the array printing density.

The module is formed as a parallelogram with the vertical edges (as seen in the figure) being angled at approximately 120° to the top and bottom edges. This angle may be regarded as the module angle. The channels are arranged such that their direction of longitudinal extension is parallel to the scanning, direction S. Each channel is around 1 mm long and around 60 μm in width.

In FIG. 4, the channels are rotated by 90° such that the direction of elongation lies perpendicular to the scanning direction S. The arrays are angled to provide the same module drop density as provided in FIG. 3, however, other angles may be chosen to provide other drop densities. As seen in FIG. 4, the angle of the array with respect to the bottom edge of the tile need not be the same as the module angle.

The relationship between channel length, channel angle, array angle, module angle and desired dpi for both the parallel and perpendicular orientated channels (with respect to the scanning direction) should be chosen to allow the modules to be butted together in a side by side relationship to build up a head that is wider than a single module with no noticeable variation in drop spacing across the entire width of the head. The relative distances between the nozzles define the drop spacing.

FIG. 5 shows two modules 50a, 50b butted side by side and comprising the vertically arranged channels. The channel spacing is such that a constant drop density is achieved across each of the modules and across the butt joint. This can lead however to an unacceptably thin wall section at the butting edges of the modules. Where the channel length is angled to the butting edge, the thickness of this section reduces along the length of the channel. As mentioned earlier, acoustic droplet generating devices have greater channel lengths than impedance droplet generating devices. This problem is therefore particularly acute with acoustic devices.

Failure of the walls at any of these points of minimum wall section can lead to at best a leaky ejection chamber and at worst an inoperative ejection chamber in the print head. Since one inoperative ejection chamber necessitates scrapping of the entire module, such failures have a severe detrimental effect on the manufacturing yield.

It has been found that the minimal wall thickness at the butting edge can be increased by offsetting the modules as shown in FIG. 6, where a neighbouring module is offset by a distance equal to half the module height (as shown in the figure). Each of the outer channels can be inset from the edges of their respective modules, providing a more robust print head whilst maintaining a constant nozzle pitch across the width of the head.

By rotating the direction of the channels through 90° it is possible to transfer the butting edge from the high-tolerance portion at the edges of the channels to the more tolerant portions at the ends of the channels as shown in FIG. 7. The outer walls of the outer channels can therefore be made thicker and more robust without affecting the pitch of the nozzles in the direction perpendicular to the scanning direction.

As mentioned earlier, the slant of the channels, the angle of the parallelogram (module angle) and the length of the array all have an effect on the amount of area available for butting. FIG. 8 depicts a further arrangement of channels to allow for robust butting of the modules. In all the previous figures, the channels have been depicted as being straight. It has been discovered by the present applicant that where the channels are formed otherwise than by sawing, for example by etching or ablation, alternative channel shapes may be used that are particularly suited to ejection using the acoustic ejection principles above.

The channels of FIG. 8 are fanned outwards from the middle channel in increasingly acute “chevrons”. A constant nozzle pitch can therefore be achieved albeit at a slightly lower pitch than if the channels were straight. The outer channels are longer than the inner channels and any obvious variations in ejection characteristics may be remedied by forming an acoustic reflection boundary modifier in either the channelled component or actuator component. These modifiers may be an insert or step or some other feature within the chamber.

Using one of the techniques that are described below to manufacture the actuator it is possible to form an actuator in the actuator component that is similarly shaped in a chevron form. These actuators are individually shaped in that they are increasingly acute chevrons to match the chevrons in the channelled component. The actuators can be further modified e.g. by changing their length or width to minimise any variations in the ejection characteristics between the channels.

Arrangements where two modules of the chevron shaped channels are butted will be described with reference to FIG. 9 and FIG. 10. Beneficially, the modules may be formed as a square or rectangular shaped tile. The channelled component and actuator component have relatively thick end wall portions along the majority of their butt edges. The end wall portion is more robust and less liable to damage when joining the modules.

The thickness of the end wall portions can be further increased using a module as described with reference to FIG. 10. The butting edges of the modules are serrated and interleaved. A constant nozzle pitch across the modules and the module join is achieved despite applying adhesive 51 between the modules to provide additional support at the butting edges and a more robust join.

Turning now to the actuator component, a typical device according to the present invention is depicted in FIG. 11.

A planar silicon body 2 is provided that has a plurality of elongate openings 4. Inside the opening is formed a structure of a piezoelectric material 8. For ease of reference only a single opening 4 and piezoelectric structure is shown.

The structure 8 of piezoelectric material can be seen to comprise a planar region 8a with angled walls 8b,8c supporting opposing edges of the planar region. In the orientation shown in the figure, the top surface of the planar region lies in the same plane as the top surface of the body.

An electrode material 7 is provided that extends over the top or outer surface of the piezoelectric structure and additionally extends over the top surface of the body and connects with adjacent piezoelectric structures located in the body.

A further electrode 6 is located on the inside or lower surface of the piezoelectric structure. This electrode acts as the active electrode and is connected to a driver circuit and may be selectively actuated in accordance with a drive signal.

The piezoelectric material is polarised by applying a polarising field between the electrodes to polarise it in the direction depicted by the arrows 5. The planar region 8a is preferably not polarised. The polarised actuator structure thus formed can be caused to deflect to eject a droplet from an ejection chamber by applying a voltage between the electrodes.

The applied field causes the walls 8b,8c of the actuator structure to thin and elongate or thicken and shorten depending on the relative directions of polarisation and applied field. This has the effect of moving the planar surface of the actuator structure out of the plane of the body component 2. The angle of the walls provides a gearing ratio that improves the ejection capabilities of the actuator.

As depicted in FIG. 12, a diaphragm plate 10 can be attached to the body to separate the ink chamber 12 from the piezoelectric structure 8. A polymeric or rubber material 13 is supplied between the outer surface of the piezoelectric structure and the diaphragm 10 to add to the structural stability provided by the silicon body 2. The material should be relatively stiff to maintain the efficiency of the diaphragm plate. Silicon rubber has been found to be particularly appropriate as it has a low shear modulus and a high bulk modulus. Where the silicon rubber is provided without the diaphragm plate, it is possible to protect against chemical attack from the ink by applying a thin coating of parylene or some other passivant.

The cover plate 14 spans the opening and serves to define, with the body, the ejection chamber 12. Application of a voltage across the walls of the piezoelectric structure deflects the diaphragm into the chamber to instigate a pressure wave propagation that causes a droplet to be ejected from the nozzle 16. The distance the diaphragm moves is of the order 10 nm.

FIG. 13, a to d depicts a way of manufacturing a component according to the present invention. Firstly, in FIG. 13a a silicon body 2 is provided of thickness preferably from 500 microns to 1 mm, that has an opening 4 formed therein. The opening is elongate and has a relative dimension of the order 1 mm by 60 μm.

Inserts 18 are provided that serve to assist the moulding process. These are a plastics material that will be removed after or during the forming of the piezoelectric structure and are preferably formed by an injection moulding technique. Further mechanical or ablative processes may be required to achieve an appropriate profile.

A former 20 is provided within the opening and is used to provide shape to the piezoelectric structure that is formed between it and the removable inserts. Piezoelectric slurry is injected into the cavity from ports (not shown) provided in the former. A plate 22 is provided to close the cavity. The removable inserts 18 are sacrificial in that they may be destroyed during a subsequent processing step.

The piezoelectric slurry comprises piezoelectric particles suspended in a matrix of an epoxy material, so as generally to be in contact. The epoxy is allowed to harden in the cavity by the application of heat (or, where it is a UV curable epoxy, through the use of UV light) to provide the initial structure. The former 20 and plate 22 are removed.

The body, piezoelectric structure and removable inserts are then heated to sinter the piezoelectric particles and burn-out the removable inserts and the epoxy matrix. As the silicon body supports the piezoelectric structure each structure is significantly isolated and shrinkage of piezoelectric structure during the sintering process may be controlled across the width of the body. The sintering process forms the actuator structure. Actuable walls are formed in the piezoelectric structure of wall thickness preferably between 15 and 70 microns.

An electrode material is subsequently deposited onto the inner and outer surfaces of the piezoelectric structure either by vacuum sputtering, electroless plating or other appropriate technique. The deposited electrodes are conveniently used to both to provide polarising fields during the manufacturing process as well as to provide driving fields during operation of the actuator structure.

FIGS. 14, a to c depict a further way of manufacturing the component of the present invention. In FIG. 14a the silicon body is etched by reactive ion etching. This creates an opening having a natural taper which may be exaggerated by any known technique.

The piezoelectric structure may be formed by a moulding technique as described above with reference to FIG. 13, or by laying down multiple thin sheets of the piezoelectric material by vacuum or pressure forming and the like.

After sintering the piezoelectric structure to form the actuator structure, in FIG. 14b, portions of the body are etched away to free the piezoelectric structure as shown in FIG. 14c. A particularly preferred method of etching is Reactive Ion Etching (RIE). RIE is a selective process in that it will remove the silicon whilst not affecting the actuator structure. Electrodes are again applied using a known technique.

Suitably, the component can be further formed using MEMS parallel processing techniques. Such a process is described with reference to FIG. 15.

A silicon plate 100 is provided in FIG. 15(a) onto which a seed plate 102 is sputtered, FIG. 15(b). A coating of silicon dioxide 104 is sputtered onto the seed plate and a layer of silicon nitride 106 deposited onto the uncoated surface of the silicon, FIGS. 15 (c) and (d). A photoresist 108 is then applied to the layer of silicon nitride by a process of spin coating or the like, FIG. 15(e).

A portion 110 of the photoresist 108 is masked and exposed, FIG. 15(f), and subsequently developed and removed, FIG. (15g). The exposed portion of the silicon nitride 106 is etched to reveal the silicon 100, FIG. 15(h). The remaining photoresist 108 is then removed, FIG. (15i).

A new layer of photoresist 112 is deposited and exposed 114 and developed as described earlier. The areas revealed by the developed photoresist are filled with a metallic material 116 though any suitable process of as depicted in FIGS. 15(j), 15(k), 15(l) and 15(m).

The undeveloped photoresist 112 is removed, FIG. 15(n), and a layer of silicon nitride 118 covered by a layer of photoresist 120 is formed, FIG. 15(o). The photoresist is exposed 122 and developed, FIG. 15(p). The uncoated portions of silicon nitride are etched and the remaining photoresist removed, FIG. 15(q).

A metallic plating 124 is sputter coated onto the substrate, FIG. 15(r), such that connections are formed between some of the lower tracks 116. A further coating of photoresist 126 is deposited, FIG. 15(s), and exposed and developed. The now exposed portion of the plating layer is etched to reveal the silicon, FIG. 15(t).

The remaining photoresist is removed and the silicon etched either through wet etching, reactive ion etching or deep reactive ion etching to form a trench 128, FIG. 15(u)

The metallic plating mask is then removed and a further seed plate 130, extending over the inner surface of the etched trench is applied, FIGS. 15(v) and 15(w). The seed plate can form both the active electrode and a keying point for the piezoelectric material 132, which is deposited in the opening to form an actuator having a concave cross-section, FIG. 15(x). The piezoelectric material is heated to form a rigid actuator structure and an inner electrode 134 is subsequently formed, FIG. 15(y).

The inner electrode and top surface of the actuator component is coated with a protective layer of silicon nitride 136 as depicted in FIG. 15(z). To the opposite, lower side of the actuator component a layer of photoresist 138 is applied that is subsequently exposed 140 and developed. The mask is used to etch the layer of silicon dioxide 104, FIGS. 15(aa), 15(ab) and 15(ac).

A new coating of photoresist 142 is then applied, exposed 144 and developed and reveals a portion of the sputtered plate 102 that is subsequently removed by etching, FIGS. 15(ad), 15(ae) and 15(af).

Next, the silicon base substrate is etched from the lower side to free the piezoelectric actuator structure. The layer of silicon dioxide is removed and a flexible diaphragm plate attached 146, FIGS. 15(ag), 15(ah), 15(ai).

FIGS. 16 a to c depict a further method of manufacturing the component using flexible green piezoelectric tape or sheets, as now commercially available. The flexible sheet 26 is loosely placed adjacent the bottom surface of the body 2 and a cover plate 28 with a port 30 located on the opposite side of the body. The port is used to subject the opening 4 in the body to reduced pressure that causes the flexible piezoelectric sheet to deform into the opening as in FIG. 16c. Alternatively, the other side may be subjected to a high pressure to force the flexible sheet to deform to the shape of a mould feature within the opening.

The body and sheet undergoes a step that fixes the flexible sheet within the opening and heat treats it to form an actuator structure. The portion of the sheet remaining outside the opening is removed (e.g. by lapping) before depositing an electrode material.

A further embodiment is depicted with regard to FIGS. 17a to 17c. In this embodiment, the actuator structure is formed using the body as a support and mould feature during manufacture and further as a support during operation of the actuator structure when it is used to eject a droplet. The silicon body is first formed with projections 32, the projections being homogenously silicon or an additional moulding component. A piezoelectric material 26 is moulded around the projections and then sintered to form the piezoelectric structure 24. Openings 34 are opened in the body behind the fired piezoelectric structure to free it and the projection is similarly removed. As mentioned earlier, the preferred method of removing the projection, where the projection is silicon, is reactive ion etching.

Where the mould feature is of a material other than silicon it may be provided by depositing or forming the structure. The material may, for example, be a photoresist. By using such materials it is possible to free the actuator without removing any of the silicon material. The formed piezoelectric structure may be half tubular and have open ends through which the photoresist is washed.

One of the benefits of the reactive ion etching technique used to remove the silicon is that it is a selective process that does not remove the piezoelectric structure.

A cover plate 14 is subsequently attached with a nozzle 16 through which ink is ejected from the ejection chamber 12. Instead of using a silicon body, a metal body or other material may be used. This can also be formed with nozzle features through which ejection fluid is ejected.

In all the above embodiments a cover plate 14, the body 2 and the piezoelectric structure 24 define the ejection channel. In alternative embodiments, depicted in FIGS. 18a and 18b the ejection channel is defined by a planar cover plate and the piezoelectric structure.

The piezoelectric structure 6 is formed as in FIGS. 13 to 16 above, however it is the inner surface of the piezoelectric structure that defines the ejection channel rather than the outer surface.

The planar cover plate may be polyimide supported on a metal plate, polyimide alone or an electroformed nozzle plate. It will be understood that a passivant may be provided over the internal surface of the actuator structure thus protecting the electrode from chemical attack.

The ejection chamber 12 is elongate with two ports 11, 13 positioned at either end. In operation, a flow of ink is generated that passes into the channel through one port and from the channel via the other. The flow of ink is preferably sufficient to remove dirt and air bubbles trapped in the channel. The flow may be continuous in that it passes through the chamber both when ink is being ejected and when ink is not being ejected.

A voltage is applied to the piezoelectric structure to cause the base of the channel to move towards and away from the nozzle 16. This initiates an acoustic pressure wave travelling longitudinally up and down the channel. At a position corresponding to the location of the ink supply ports 11, 13 the pressure wave is reflected by the acoustic boundary and travel back up the channel to converge at the nozzle and eject a droplet.

The structure can also be modified as depicted in FIGS. 19a and 19b. In this embodiment the cover plate of FIG. 18 is replaced by a flexible diaphragm incorporating a nozzle plate. Whilst the diaphragm and nozzle plate have been drawn as separate components it is equally applicable to provide it them as a single component.

As the piezoelectric structure deforms in use the flexible diaphragm also deforms. Ink is allowed to circulate through the channel as described with reference to FIG. 7. The inlet and outlet ports being provided in a separate plate 15.

It is of course possible to form the actuator structure onto a base without it being located in an opening as shown in FIG. 20 and FIG. 21.

The arrangement depicted in FIG. 20 has close similarities with that shown in FIG. 19, with the differences that the piezoelectric structure 6 is formed on a planar body which serves as a cover plate 15 defining ports 11,13; and that the nozzle plate 9 is carried directly on the piezoelectric structure.

In an alternative arrangement depicted in FIG. 21, a hemi-cylindrical piezoelectric structure 6 is formed on a plate 15 serving both as a cover plate and a nozzle plate. The structure 6 may be formed with—for example—one of the techniques described previously, supported during manufacture on photoresist or other sacrificial material subsequently burnt away. Electrodes 7 and 8 formed on the exterior and interior surfaces of the piezoelectric structure serve during manufacture to polarise the piezoelectric material in the arrowed direction and also serve in use to apply the actuating fields. The thickness of the piezoelectric structure is preferably around 15 microns with a channel width of around 200 microns and length around 1 mm. The thickness of the cover/nozzle plate may be between 25 and 125 microns with a nozzle 16 of between 25 and 50 microns. If appropriate, the nozzle may be formed in a separate nozzle plate bonded to a somewhat thicker cover plate.

With piezoelectric actuators a number of different forms of actuation are possible including direct mode, shear mode or bending mode. Direct mode utilises the d33 and d31 modes of piezoelectric material and shear mode d15.

Each feature disclosed in the description, and/or the claims and drawings may be provided independently or in any appropriate combination. Any single feature from an embodiment may be included in the other embodiments. Any feature of a subsidiary claim may be incorporated in a claim from which it is not dependent.

Also, any described channelled component and any described actuator component may be utilised together.

1. An actuator component for a drop on demand ink jet printer, said component comprising a body having a top surface, an opening in said top surface extending in an opening direction into said body along an opening axis, an actuator structure located substantially within said opening and an electrode, said electrode being disposed so as to be able to apply a field to said actuator structure to cause said actuator structure to deform.

2-3. (canceled)

4. A component according to claim 1, wherein said actuator structure extends as an impermeable wall across said opening.

5. A component according to claim 1, wherein said actuator structure tapers along said opening axis.

6. A component according to claim 5, wherein said actuator structure comprises a flat portion at the end of said taper; said flat portion comprising an upper surface and a lower surface; said upper and lower surfaces lying parallel with said top and bottom surfaces.

7-8. (canceled)

9. A component according to claim 6, wherein both said top surface and said bottom surface can move in said opening direction.

10. (canceled)

11. A component according to any claim 1, wherein a plurality of openings is provided; each of said openings comprising a respective actuator structure.

12-14. (canceled)

15. A component according to claim 1, wherein said opening is elongate in a direction perpendicular to said opening axis, said opening being a channel.

16-19. (canceled)

20. A component for ejecting a droplet in a direction of droplet flight, said component comprising an actuator structure displaceable by actuation in the direction of said droplet flight; said actuator defining in part an ejection chamber and comprising a port through which said droplet is ejected.

21. A component according to claim 20, further comprising an electrode, said electrode being disposed so as to be able to apply a field to said actuator structure to cause said actuator structure to deform.

22. A component according to claim 20, wherein said actuator structure comprises elongate channel walls defining an elongate channel.

23. A component according to claim 22, wherein said actuator structure provides a convex cross section when a cross section is taken orthogonal to the channel length.

24. A component according to claim 23, wherein said port is provided in the roof of said convex cross-section.

25. A component according to claim 22, wherein said actuator structure cross section tapers in said direction of droplet flight.

26. A component according to claim 25, wherein said actuator comprises a flat portion at the end of said taper; said flat portion comprising an upper surface and a lower surface; said upper and lower surfaces lying on planes orthogonal to said direction of droplet flight.

27. A component according to claim 20, wherein said actuator structure is homogenous.

28. A component according to claim 20, wherein said actuator structure is mounted to a base; said base providing one wall of said ejection chamber.

29. A method of forming a component for an ink jet print head comprising the steps of a) providing a body having a mold feature, b) forming a deformable actuator structure, the shape of said actuator structure being defined, at least in part by said mold feature, c) removing at least a portion of said mold feature, and d) providing an electrode, said electrode being disposed so as to be able to apply a field to said actuator structure to cause said actuator structure to deform while said actuator structure is attached to said body.

30. A method according to claim 29, wherein said mold feature is provided by adding a material to a surface of said body.

31. A method according to claim 30, wherein said surface is a top surface.

32. A method according to claim 30, wherein said surface is a surface bounding an opening extending into said body.

33. A method according to claim 30, wherein said material is a photoresist.

34. A method according to claim 29, wherein said mold feature is provided by removing material from a surface of said body.

35. A method according to claim 34, wherein said material is removed by etching.

36. A method according to claim 29, wherein the step of forming said electrode comprises a first step of forming a first electrode layer and a second step of forming a second electrode layer.

37. A method according to claim 36, wherein said first electrode layer is formed before forming said deformable actuator structure.

38. A method according to claim 37, wherein in the step of forming said actuator structure, said electrode is immersed in a suspension comprising dispersed particles.

39. A method according to claim 38, wherein said dispersed particles comprise piezoelectric material.

40. A method according to claim 38 comprising immersing a deposition electrode in said suspension with said electrode, and applying a voltage therebetween and thereby depositing said dispersed particles on said electrode.

41. A method according to claim 36, wherein said second electrode layer is formed after forming said deformable actuator structure.

42. A method according to claim 29, comprising removing at least a portion of said mold feature by etching.

43. A method according to claim 29, comprising removing at least a portion of said mold feature by washing.

44. A method according to claim 29, comprising removing at least a portion of said mold feature by application of heat.

45. A method of forming a component for an ink jet print head comprising the steps of a) providing a body having a top surface, b) forming a plurality of openings in said top surface and extending into said body, and c) forming within each said opening an actuator structure; each said actuator structure remaining attached to said body during actuation.

46. A method according to claim 45, wherein said actuator structures are isolated actuator structures.

47. (canceled)

48. A method according to claim 45, comprising forming said opening by etching material from said top surface.

49. A method according to claim 48, comprising applying a mask to the body and wherein the opening thus formed tapers with increasing depth.

50. A method according to claim 45, comprising applying an electrode to an inner surface of said opening.

51. A method according to claim 50, comprising immersing said electrode in a suspension comprising dispersed particles.

52. A method according to claim 51, wherein said dispersed particles comprise piezoelectric material.

53. A method according to claim 51, comprising immersing a deposition electrode in said suspension with said first electrode, and applying a voltage therebetween and thereby depositing said dispersed particles on said first electrode.

54. A method according to claim 53, comprising heating said deposited dispersed particles to form said actuator structure.

55. A method according to claim 45, comprising the steps supplying a slurry comprising particles within said opening, the slurry at least partly conforming to the shape of said opening.

56. A method according to claim 55, wherein said particles are of a piezoelectric material.

57. A method according to claim 55, comprising heating said slurry to form said actuator structure.

58. A method according to claim 45 to claim 49, comprising laying a flexible sheet of a piezoelectric material within said opening by applying a pressure difference thereto; said sheet at least partly conforming to the shape of said opening.

59. A method according to claim 58, comprising heat treating said sheet to form said actuator structure.

60. A method according to claim 45, comprising depositing a film of piezoelectric material within said opening using a sputtering process; said film at least partly conforming to the shape of said opening.

61. A method according to claim 59, wherein said sputtering process comprises three metal targets of lead, titanium and zirconium.

62. A method according to claim 60, comprising heat treating said film to form said actuator structure.

63. A channelled component for a drop on demand ink jet printer comprising elongate channel walls defining a plurality of elongate liquid channels, each channel comprising one wall that is resiliently deformable in an actuation direction orthogonal to the channel length; a respective ejection nozzle connected with the channel at a point intermediate its length; a liquid supply providing for continuous flow of liquid along said channel; acoustic boundaries at respective opposite ends of the channel serving to reflect acoustic waves in the liquid of the channel wherein the inter-channel spacing of said acoustic boundaries is different to the inter-channel spacing of said nozzles.

64. A channelled component according to claim 63, wherein the inter-channel spacing of said acoustic boundaries is less than that of the inter-channel spacing of said nozzles.

65. A channelled component according to claim 63, wherein channels are chevron-shaped.

66. A channelled component according to claim 65, wherein a series of chevron-shaped channels is arranged to one side of a straight channel, the angle of said chevron-shaped channels being more acute with increasing distance from said straight channel.

67. A channelled component according to claim 66, wherein a reversed second series of chevron-shaped channels is arranged on the opposite side of said straight channel.

68. A channelled component according to claim 63, wherein said channels are arranged on a tile, an array of nozzles extending linearly across said tile.

69. A channelled component according to claim 68, wherein a plurality of like tiles are butted together along respective edges and wherein there is provided an array of nozzles having an equal linear nozzle spacing across the width of the like tiles and across the butt joint.

70. A channelled component according to claim 69, wherein said respective edges are serrated.

71. A channelled component according to claim 70, wherein the serrations of respective edges are interleaved.

72-73. (canceled)

74. A component according to claim 1, wherein said opening defines at least in part an ink jet chamber.

75. A component according to claim 28, wherein said body is formed of silicon or alumina.
